(19) United States
(12) Patent Application Publication
(10) Pub. No.: US 2014/0133083 A1
(43) Pub. Date: May 15, 2014

(54) GRAPHICS CARD AND BASE PLATE AND CORE BOARD FOR THE GRAPHICS CARD

(71) Applicant: NVIDIA CORPORATION, Santa Clara, CA (US)

(72) Inventor: Xi Wu, Shenzhen (CN)

(73) Assignee: NVIDIA CORPORATION, Santa Clara, CA (US)

(21) Appl. No.: 13/754,349

(22) Filed: Jan. 30, 2013

(30) Foreign Application Priority Data
Nov. 9, 2012 (CN) 201210448878.2

(51) Int. Cl. G06F 1/16

(52) U.S. Cl. CPC G06F 1/16
USPC 361/679.32

(57) ABSTRACT

The present invention discloses graphics card and base plate and core board for the graphics card. The graphics card includes a base plate and a core board, wherein the base plate includes a base plate PCB and a core board interface slot, a power module and a graphics output interface located on the base plate PCB; the core board includes a core board PCB and a base plate interface and a graphics processing module located on the core board PCB, and the core board is accommodated in the core board interface slot of the base plate and electrically connected with the base plate via the base plate interface; the graphics processing module receives a power signal from the power module and output graphic data for being displayed via the base plate interface; the graphics output interface is used to output the graphic data for being displayed.

### CROSS-REFERENCE TO RELATED APPLICATIONS

This application claims priority to Chinese Patent Application No. 201210448878.2, filed on Nov. 9, 2012, which is hereby incorporated herein by reference.

### BACKGROUND OF THE INVENTION

1. Field of the Invention

The present invention relates generally to graphics processing, and in particular, to a graphics card and a base plate and a core board for the graphics card.

2. Description of the Related Art

Graphics card, which is one of the most basic components of a personal computer, takes on the task of outputting graphics for being displayed. Currently, technology of electronics industry becomes more and more complex, and the integration level of electronics elements grows ever higher and the power consumption is ever larger. Therefore layers of graphics card PCB become more and more. The existing high-end graphics cards generally employ a multi-layer PCB design. However, the increasing number of PCB layers increases product costs greatly. For example, for a common graphics card, the cost of an eight-layer PCB is 50%-70% higher than that of a six-layer PCB, though the former only has two more layers than the latter. Moreover, a graphics processing unit (GPU), a memory, a power module and an IO interface are integrated on a single PCB in an existing graphics card, but the update of a GPU and a memory is very fast and the improvement of a power module and an IO interface is relatively slow. Therefore integrating those elements on a single PCB goes against effective utilization of resources, a simple design, low product costs and short product cycle.

Therefore, there is a need for an optimized graphics card design to reduce the waste of resources and lower costs.

### SUMMARY OF THE INVENTION

A series of concepts in abbreviated forms are introduced in the summary of the invention, which will be further explained in detail in the part of detailed description. This part of the present invention does not mean trying to define key features and essential technical features of the technical solution claimed for protection; even not mean trying to determine a protection scope of the technical solution claimed for protection.

In order to solve the above problem, the present invention discloses a base plate for a graphics card, including: a base plate PCB and a core board interface slot, a power module and a graphics output interface located on the base plate PCB, wherein the core board interface slot is used to accommodate and be electrically connected with a core board which is replaceable; the power module is used to power the core board via the core board interface slot; and the graphics output interface is used to output graphic data for being displayed that are received from the core board via the core board interface slot.

In an alternative embodiment of the present invention, the base plate further includes a base plate interface for being connected with another base plate.

In an alternative embodiment of the present invention, the base plate PCB is a multi-layer board including at least one signal layer and at least one power layer.

In an alternative embodiment of the present invention, the multi-layer board is a four-layer plate including two signal layers located respectively at a first layer and a forth layer of the base plate PCB and two power layers located respectively at a second layer and a third layer of the base plate PCB.

In an alternative embodiment of the present invention, the multi-layer board is a six-layer plate including two power layers located respectively at a second layer and a fifth layer of the base plate PCB and four signal layers located respectively at a first layer, a third layer, a forth layer and a sixth layer of the base plate PCB.

In an alternative embodiment of the present invention, the multi-layer board is a six-layer plate including four power layers located respectively at a second layer, a third layer, a forth layer and a fifth layer of the base plate PCB and two signal layers located respectively at a first layer and a sixth layer of the base plate PCB.

In an alternative embodiment of the present invention, the base plate further includes a PCIE interface located on the base plate PCB and used to receive a data signal and a control signal that are to be transmitted to the core board via the core board interface slot.

In an alternative embodiment of the present invention, the base plate further includes a power interface, which is located on the base plate PCB, connected with the power module and used for being connected with an external power.

In an alternative embodiment of the present invention, the power module includes a graphics processing unit power module for powering a graphics processing unit of the core board via the core board interface slot and a memory power module for powering a memory of the core board via the core board interface slot.

In another aspect of the invention, a core board for a graphics card is also provided. The core board includes: a core board PCB and a base plate interface and a graphics processing module located on the core board PCB, wherein the core board is used to be accommodated into a core board interface slot of a base plate and electrically connected with the base plate via the base plate interface; and the graphics processing module is used to receive a power signal from the base plate and output graphic data for being displayed via the base plate interface.

In an alternative embodiment of the present invention, the core board PCB is a six-layer plate including four signal layers located respectively at a first layer, a third layer, a forth layer and a sixth layer of the core board PCB and two power layers that are two ground layers located respectively at a second layer and a fifth layer of the core board PCB.

In yet another aspect of the invention, a graphics card is also provided. The graphics card includes a base plate and a core board, wherein the base plate includes a base plate PCB and a core board interface slot, a power module and a graphics output interface located on the base plate PCB; the core board includes a core board PCB and a base plate interface and a graphics processing module located on the core board PCB, and the core board is accommodated in the core board interface slot of the base plate and electrically connected with the base plate via the base plate interface; the graphics processing module receives a power signal from the power module and output graphic data for being displayed via the base plate interface; the graphics output interface is used to output the graphic data for being displayed that are received from the core board.

In an alternative embodiment of the present invention, the base plate further includes a base plate interface for being connected with another base plate.

In an alternative embodiment of the present invention, the core board PCB is a six-layer plate including four signal layers located respectively at a first layer, a third layer, a forth layer and a sixth layer of the core board PCB and two power layers that are two ground layers located respectively at a second layer and a fifth layer of the core board PCB.

In an alternative embodiment of the present invention, the base plate PCB is a four-layer plate including two signal layers located respectively at a first layer and a forth layer of the base plate PCB and two power layers located respectively at a second layer and a third layer of the base plate PCB.

In an alternative embodiment of the present invention, the base plate PCB is a six-layer plate including two power layers located respectively at a second layer and a fifth layer of the base plate PCB and four signal layers located respectively at a first layer, a third layer, a forth layer and a sixth layer of the base plate PCB.

In an alternative embodiment of the present invention, the base plate PCB is a six-layer plate including four power layers located respectively at a second layer, a third layer, a forth layer and a fifth layer of the base plate PCB and two signal layers located respectively at a first layer and a sixth layer of the base plate PCB.

In an alternative embodiment of the present invention, the base plate further includes a PCIE interface located on the base plate PCB and used to receive a data signal and a control signal that are to be transmitted to the core board via the core board interface slot.

In an alternative embodiment of the present invention, the base plate further includes a power interface, which is located on the base plate PCB, connected with the power module and used for being connected with an external power.

In an alternative embodiment of the present invention, the graphics processing module includes a graphics processing unit and a memory, and the power module includes a graphics processing unit power module for powering the graphics processing unit via the core board interface slot and a memory power module for powering the memory via the core board interface slot.

The graphics card provided by the present invention may be divided into two parts: a base plate and a core board, which achieves different functions with different configuration and is beneficial to the replacement of the graphics card. Furthermore, the graphics card described herein reduces product costs and improves the performance of graphics processing system.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1a illustrates a schematic block diagram of a base plate for a graphics card, according to an embodiment of the present invention;

FIG. 1b illustrates a schematic block diagram of a base plate for a graphics card, according to another embodiment of the present invention;

FIG. 2a illustrates a cross section view of a base plate PCB, according to an embodiment of the present invention;

FIG. 2b illustrates a cross section view of a base plate PCB, according to another embodiment of the present invention;

FIG. 2c illustrates a cross section view of a base plate PCB, according to yet another embodiment of the present invention;

FIG. 3 illustrates a schematic block diagram of a core board for a graphics card, according to an embodiment of the present invention;

FIG. 4 illustrates a cross section view of a core board PCB, according to an embodiment of the present invention;

FIG. 5 illustrates a schematic block diagram of a graphics card, according to an embodiment of the present invention.

### DETAILED DESCRIPTION

A plenty of specific details are presented so as to provide more thoroughly understanding of the present invention in the description below. However, the present invention may be implemented without one or more of these details, as is obvious to those skilled in the art. In other examples, some of the technical features known in the art are not described so as to avoid confusions with the present invention.

Detailed structures will be presented in the following description for more thoroughly appreciation of the invention. Obviously, the implementation of the invention is not limited to the special details well-known by those skilled in the art. Preferred embodiments are described as following; however, the invention could also comprise other ways of implementations.

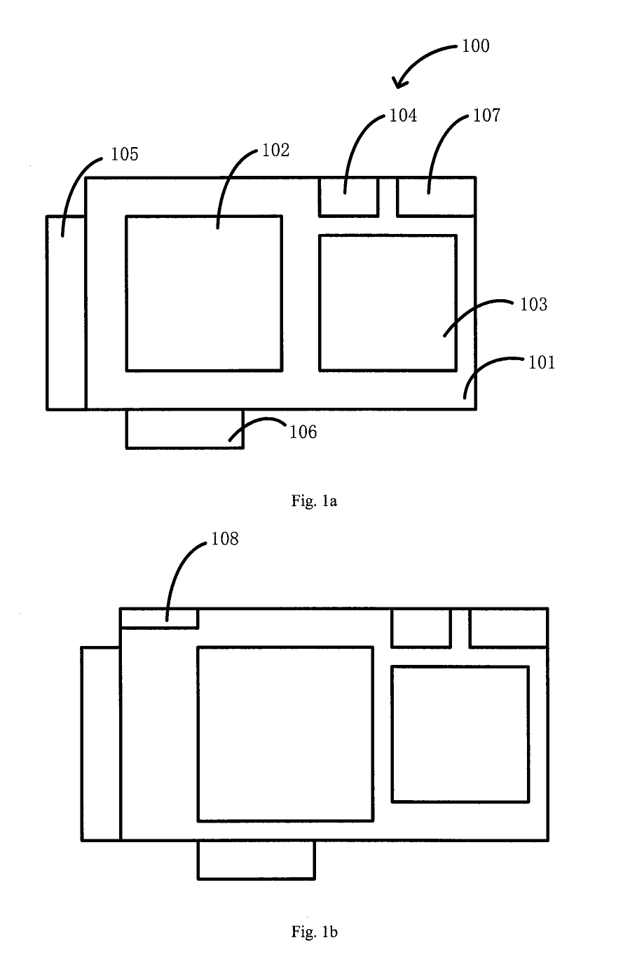

The present invention provides a base plate for a graphics card. FIG. 1a illustrates a schematic block diagram of a base plate for a graphics card 100 according to an embodiment of the present invention. As shown in FIG. 1a, the base plate 100 includes: a base plate PCB 101 and a core board interface slot 102, a power module and a graphics output interface 105 located on the base plate PCB 101. The core board interface slot 102 is used to accommodate and be electrically connected with a core board which is replaceable. The power module is used to power the core board via the core board interface slot. The graphics output interface 105 is used to output graphic data for being displayed that are received from the core board via the core board interface slot 102. The graphics output interface 105 may be any interface, for example, an S port, a VGA interface, a DVI interface, etc., that is capable of implementing graphic data output. The core board is convenient to be replaced since the core board is plugged onto the base plate 100 through the core board interface slot, which is beneficial to the upgrade of the core board.

Optionally, the power module may be a separate module. Preferably, the power module includes a graphics processing unit power module 103 for powering a graphics processing unit of the core board via the core board interface slot 102 and a memory power module 104 for powering a memory of the core board via the core board interface slot 102. The power module may configure external power to be applied to the core board and then apply the configured power to the core board via the core board interface slot 102. The external power may be power from a computer motherboard, a main power supply of a computer or other external powers.

Optionally, the base plate 100 may further include a PCIE interface 106 located on the base plate PCB 101 and used to receive a data signal and a control signal that are to be transmitted to the core board via the core board interface slot 102. The data signal or the control signal may be from a main processor, such as a CPU or a DSP of a computer. Therefore, the PCIE interface 106 enables a graphics card configured with the base plate to realize communication with the main processor.

Optionally, the base plate 100 may further include a power interface 107, which is located on the base plate PCB 101, connected with the power module and used for being connected with an external power. The power interface 107 transmits power from the external power to the power module for being processed by the power module. Therefore, the external power may supply power to the base plate 100 through the power interface 107. Optionally, the power interface 107 may be a D-4PIN power interface, an 8PIN power interface, a double 6PIN power interface and an 8+6PIN interface, etc.

Optionally, the base plate 100 may further include a base plate interface for being connected with another base plate. FIG. 1b illustrates a schematic block diagram of a base plate for a graphics card according to another embodiment of the present invention. Referring to FIG. 1b, the base plate may also include a base plate interface 108 for being connected with another base plate except of the components described above. The base plate interface 108 may realize interconnection between two base plates, and further realize interconnection between two graphics cards comprising the two base plates. Therefore, the two graphics cards may communicate with each other through the base plate interface 108. Persons of ordinary skill in the art will understand that the base plate interface may be any interface, for example, a MIO interface, which can realize interconnection between two base plates.

Optionally, the base plate PCB 101 may be a multi-layer board including at least one signal layer and at least one power layer. Multi-layer board design may meet the needs of high current and large power consumption, such that a graphics card configured with the base plate PCB could do more complex graphics processing and calculating and show better performance.

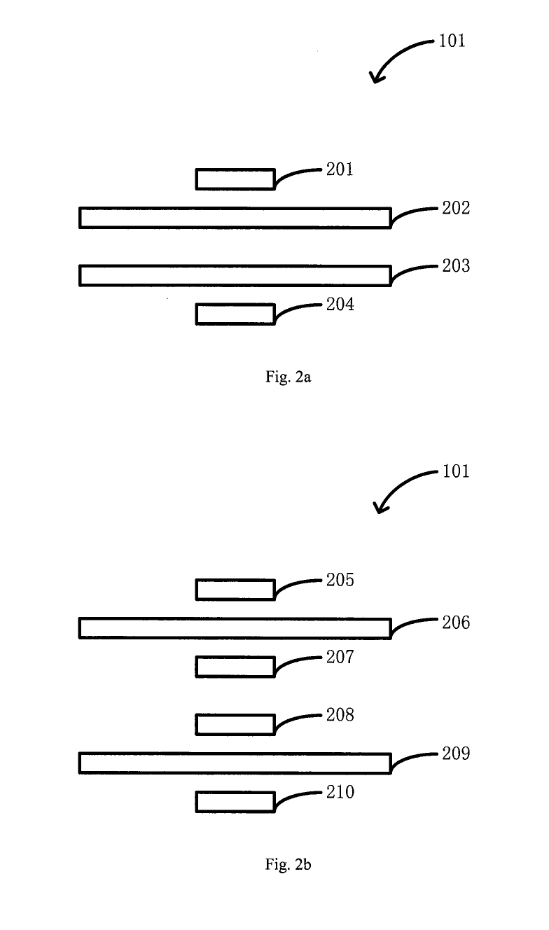

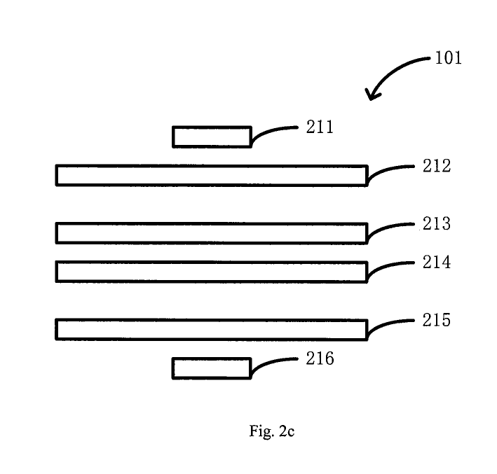

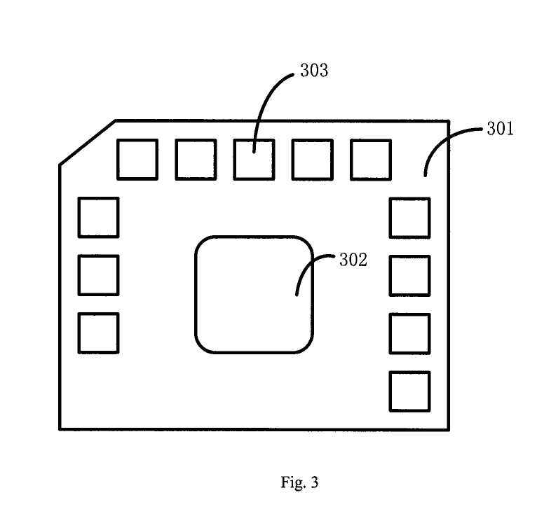

Optionally, the multi-layer board may be a four-layer plate including two signal layers located respectively at a first layer and a forth layer of the base plate PCB and two power layers located respectively at a second layer and a third layer of the base plate PCB. FIG. 2a illustrates a cross section view of a base plate PCB 101 according to an embodiment of the present invention. As shown in FIG. 2a, the base plate PCB 101 is a four-layer plate, wherein the first layer 201 and the forth layer 204 are signal layers and the second layer 202 and the third layer 203 are power layers. A VCC layer and a GND layer are collectively referred to as power layers in the present invention. When the number of IO interfaces on the base plate 100 is relatively small and the power of the graphics processing unit power module is not very large, the four-layer PCB shown in the present embodiment may be used. The cost of the four-layer PCB is low. Optionally, the thickness of the signal layers 201 and 204 for transmitting signals may be 1 oz, while the thickness of the power layers 202 and 203 may be 1 oz or 2 oz as needed. For example, the power layers 202 and 203 may employ copper foil of 1 oz thickness when the required current flow is relatively small and the power layers 202 and 203 may employ copper foil of 2 oz thickness when the required current flow is relatively large. With the same line width, the thicker the copper foil is, the stronger the conductive ability thereof is.

Optionally, the multi-layer board may be a six-layer plate including two power layers located respectively at a second layer and a fifth layer of the base plate PCB and four signal layers located respectively at a first layer, a third layer, a forth layer and a sixth layer of the base plate PCB. FIG. 2b illustrates a cross section view of a base plate PCB 101 according to another embodiment of the present invention. As shown in FIG. 2b, the base plate PCB 101 is a six-layer plate, wherein the first layer 205, the third layer 207, the forth layer 208 and the sixth layer 210 are signal layers and the second layer 206 and the fifth layer 209 are power layers. When the number of IO interfaces on the base plate is relatively large, the six-layer PCB shown in the present embodiment may be used. Optionally, a signal layer may be used as a power layer to increase power channels.

Optionally, the multi-layer board may be a six-layer plate including four power layers located respectively at a second layer, a third layer, a forth layer and a fifth layer of the base plate PCB and two signal layers located respectively at a first layer and a sixth layer of the base plate PCB. FIG. 2c illustrates a cross section view of a base plate PCB 101 according to yet another embodiment of the present invention. As shown in FIG. 2c, the base plate PCB 101 is a six-layer plate, wherein the first layer 211 and the sixth layer 216 are signal layers and the second layer 212, the third layer 213, the forth layer 214 and the fifth layer 215 are power layers. When the number of IO interfaces on the base plate 100 is relatively small, the six-layer PCB shown in the present embodiment may be used. All of inner layers of the six-layer PCB are power layers, thus allowing the area of effective power channels to be larger and a larger current flow to be transmitted.

In another aspect of the invention, a core board for a graphics card is also provided. FIG. 3 illustrates a schematic block diagram of a core board for a graphics card 300 according to an embodiment of the present invention. The core board 300 includes: a core board PCB 301 and a base plate interface (not shown) and a graphics processing module located on the core board PCB 301, wherein the core board 300 is used to be accommodated into a core board interface slot of a base plate and electrically connected with the base plate via the base plate interface; and the graphics processing module is used to receive a power signal from the base plate and output graphic data for being displayed via the base plate interface. The graphics processing module may include a graphics processing unit 302 and a memory 303. The core board is plugged onto the base plate through the base plate interface, so that the core board is detachable, which is beneficial to the replacement of the core board, thus saving costs.

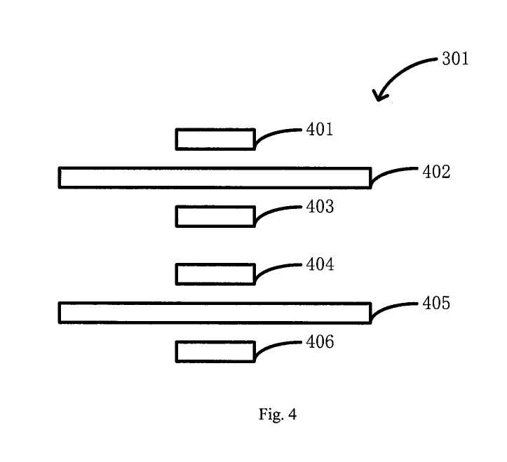

Optionally, the core board PCB 301 may be a six-layer plate including four signal layers located respectively at a first layer, a third layer, a forth layer and a sixth layer of the core plate PCB 301 and two power layers that are two ground layers located respectively at a second layer and a fifth layer of the core board PCB 301. FIG. 4 illustrates a cross section view of a core board PCB 301 according to yet another embodiment of the present invention. As shown in FIG. 4, the core board PCB 301 is a six-layer plate, wherein the first layer 401, the third layer 403, the forth layer 404 and the sixth layer 406 are signal layers and the second layer 402 and the fifth layer 405 are power layers. Optionally, a signal layer may also be used as a power layer. For example, a GDDR5 memory typically requires three wiring layers, thus one signal layer may be used as a power layer only for conduction of memory power and some small power and with little current flow thereon. The core board PCB being a six-layer plate is beneficial to configuration of more memory particles with higher performance and to the improvement of the core board's performance.

Persons of ordinary skill in the art will understand that insulating layers could be provided between various layers with respect to the base plate PCB and the core board PCB described above.

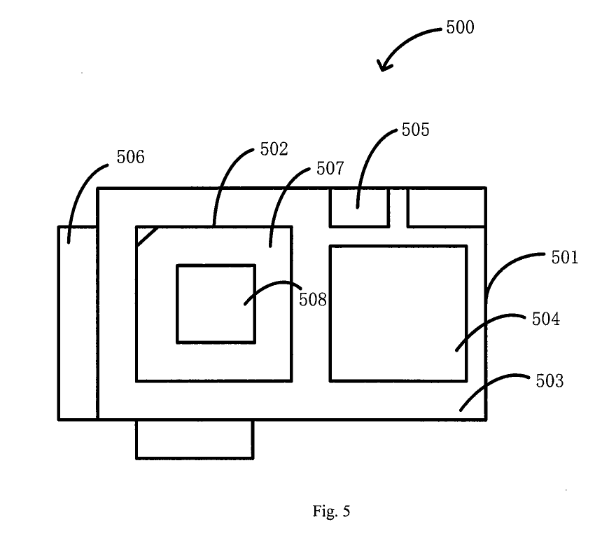

In yet another aspect of the present invention, a graphics card is also provided. FIG. 5 is a schematic block diagram of a graphics card 500 according to an embodiment of the present invention. As shown in FIG. 5, the graphics card 500 includes a base plate 501 and a core board 502. The base plate 501 includes a base plate PCB 503 and a core board interface slot (not shown), a power module and a graphics output interface 506 located on the base plate PCB. The core board 502 includes a core board PCB 507 and a base plate interface (not shown) and a graphics processing module 508 located on the core board PCB 507. The core board 502 is accommodated in the core board interface slot of the base plate 501 and electrically connected with the base plate 501 via the base plate interface. The graphics processing module 508 receives a power signal from the power module and output graphic data for being displayed via the base plate interface. The graphics output interface 506 is used to output the graphic data for being displayed that are received from the core board 502.

Similar with the related description of the above base plate, the power module may include a graphics processing unit power module 504 and a memory power module 505.

The base plate and the core board involved in the above graphics card have been described in the description about embodiments for the base plate and the core board. For brevity, a detailed description thereof is omitted. Those skilled in the art can understand that specific structure and operation mode of the graphics card with reference to FIG. 1 to FIG. 4 in combination with the above description.

The core board 502 is replaceable. Different ways of combining the base plate 501 and the core board 502 may be realized by standardizing the core board interface slot and the base plate interface. Several different combination schemes of the base plate and the core board that may realize the function of a single ten-layer plate (including four layers of 2 oz copper) are illustrated below. According to an embodiment of the present invention, the core board PCB is a six-layer plate with an area of 95×118 mm². The base plate PCB may be a six-layer plate or a four-layer plate. The four-layer plate may include only copper foil of 1 oz thickness or include copper foil of both 1 oz and 2 oz thickness depending on the size of power required by the core board. In addition, if the base plate is provided with a base plate interface, then the area of the base plate PCB is 111×267 mm², or else the area of the base plate PCB is 111×230 mm². Therefore, there are at least six combination schemes of the base plate and the core board.

Table 1 shows the costs of multi-layer PCB with different configuration.

TABLE 1
The costs of multi-layer PCB with different configuration

| | | | |
|---|---|---|---|
| Six-layer | 95 × 118 mm² | 111 × 230 mm² | 111 × 267 mm² |
| Cost | 15.6 | 39 | 45.3 |
| (RMB) | | | |
| Four- | | 111 × 230 mm² | 111 × 267 mm² |
| layer | | | |
| Cost | | 19.5 | 22.6 |
| (RMB) | | | |
| Four- | | 111 × 230 mm² | 111 × 267 mm² |
| layer | | (including | (including |
| | | 2 layers of | 2 layers |
| | | 2 oz copper) | of 2 oz copper) |
| Cost | | 32.2 | 37.4 |
| (RMB) | | | |
| Ten-layer | | 111 × 230 mm² | |
| | | (including 4 layers of | |
| | | 2 oz copper) | |
| Cost | | 84.2 | |
| (RMB) | | | |

The above six combination schemes are:

1. A six-layer base plate of 111×230 mm² plus a six-layer core board;

2. A six-layer base plate of 111×267 mm² plus a six-layer core board;

3. A four-layer base plate of 111×230 mm² plus a six-layer core board;

4. A four-layer base plate of 111×267 mm² plus a six-layer core board;

5. A four-layer base plate of 111×230 mm² (including 2 layers of 2 oz copper) plus a six-layer core board;

6. A four-layer base plate of 111×267 mm² (including 2 layers of 2 oz copper) plus a six-layer core board.

Table 2 shows the costs of different types of combinations of the base plate and the core board.

TABLE 2
The costs of different types of combinations of the base plate and the core

| | | | | Single ten- |
|---|---|---|---|---|
| | | | | layer |
| | four-layer | four-layer base | | plate |
| | base plate | plate (including 2 | | (including |
| | plus six- | layers of 2 oz | Six-layers base | 4 layers |
| Type of | layer core | copper) plus six- | plate plus six- | of 2 oz |
| combination | board | layer core board | layer core board | copper) |
| cost((RMB)) | 15.6 + 19.5 = | 15.6 + 32.2 = 47.8 | 15.6 + 39 = 54.6 | 84.2 |
| ((area of the | 35.1 | | | |
| base plate: | | | | |
| 111 × 230 mm²) | | | | |
| cost((RMB)) | 15.6 + 22.6 = | 15.6 + 37.4 = 53.0 | 15.6 + 45.3 = 60.9 | |
| ((area of the | 38.2 | | | |
| base plate: | | | | |
| 111 × 267 mm²) | | | | |

The results of computing the cost ratios of various schemes to a single ten-layer plate respectively are shown below:

1. A six-layer base plate of 111×230 mm² plus a six-layer core board: 41.7%;

2. A six-layer base plate of 111×267 mm² plus a six-layer core board: 45.4%;

3. A four-layer base plate of 111×230 mm² plus a six-layer core board: 56.8%;

4. A four-layer base plate of 111×267 mm² plus a six-layer core board: 63.0%;

5. A four-layer base plate of 111×230 mm² (including 2 layers of 2 oz copper) plus a six-layer core board: 64.9%;

6. A four-layer base plate of 111×267 mm² (including 2 layers of 2 oz copper) plus a six-layer core board: 72.3%.

Therefore, the costs of the six combination schemes are 27.7%-58.3% lower than the cost of the single ten-layer plate. So the type of graphics card implemented with combination of a base plate and a core board has lower cost than an integrated graphics card.

According to the graphics card provided by the present invention, the wiring of a memory is laid on the core board instead of the base plate, and therefore the effective channel area of a power layer of the base plate may be doubled approximately, thus enabling copper foil of the power layer of the base plate to become thinner. From Table 1 and Table 2, with the same line width, the thinner the copper foil is, the lower the cost is. Therefore, the decreasing thickness of the copper foil is beneficial to the reduction of the cost. In addition, the IR drop of the power of the graphics processing unit of the graphics card is reduced and the load capacity thereof is strengthened due to the increase in the effective channel area. The power of the graphics processing unit rises vertically to the core board from the base plate and is only at the central portion of the graphics processing unit, thus the number of layers of the core board does not affect the power of the graphics processing unit. The power of the graphics processing unit and the memory information are completely separated, which may eliminate the influence of the power of the graphics processing unit on the memory information, thus enhancing the stability of a graphics processing system and improving the over clocking ability of the system.

According to the graphics card provided by the present invention, which may be divided into two parts, the connection interface of the base plate and the core board may be standardized, so that the graphics card may be configured to be different combinations of the base plate and the core board in order to realize different functions to meet a variety of user requirements. Although GPU is quickly updated, modular design makes what is needed is just replacing the core board and the mature base plate may be reused when the GPU is being updated. Furthermore, the independence of module functions and the consistency of interfaces make the base plate and the core board be designed, developed and tested in parallel and problematic modules be identified and replaced in time. Therefore, modular design may shorten production cycle, improve production efficiency, lower production costs and have greater market advantages.

The present invention has been described through the above-mentioned embodiments. However, it will be understand that the above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

1. A base plate for a graphics card including:
a base plate PCB;
a core board interface slot located on the base plate PCB; and
a power module and a graphics output interface located on the base plate PCB, wherein
the core board interface slot is used to accommodate and be electrically connected with a core board which is replaceable;
the power module is used to power the core board via the core board interface slot; and
the graphics output interface is used to output graphic data for being displayed that are received from the core board via the core board interface slot.

2. The base plate of claim 1, wherein the base plate further includes a base plate interface for being connected with another base plate.

3. The base plate of claim 1, wherein the base plate PCB is a multi-layer board including at least one signal layer and at least one power layer.

4. The base plate of claim 3, wherein the multi-layer board is a four-layer plate including two signal layers located respectively at a first layer and a forth layer of the base plate PCB and two power layers located respectively at a second layer and a third layer of the base plate PCB.

5. The base plate of claim 3, wherein the multi-layer board is a six-layer plate including two power layers located respectively at a second layer and a fifth layer of the base plate PCB and four signal layers located respectively at a first layer, a third layer, a forth layer and a sixth layer of the base plate PCB.

6. The base plate of claim 3, wherein the multi-layer board is a six-layer plate including four power layers located respectively at a second layer, a third layer, a forth layer and a fifth layer of the base plate PCB and two signal layers located respectively at a first layer and a sixth layer of the base plate PCB.

7. The base plate of claim 1, wherein the base plate further includes a PCIE interface located on the base plate PCB and used to receive a data signal and a control signal that are to be transmitted to the core board via the core board interface slot.

8. The base plate of claim 1, wherein the base plate further includes a power interface, which is located on the base plate PCB, connected with the power module and used for being connected with an external power.

9. The base plate of claim 1, wherein the power module includes a graphics processing unit power module for powering a graphics processing unit of the core board via the core board interface slot and a memory power module for powering a memory of the core board via the core board interface slot.

10. A core board for a graphics card including:
a core board PCB;
a base plate interface; and
a graphics processing module located on the core board PCB, wherein
the core board is used to be accommodated into a core board interface slot of a base plate and electrically connected with the base plate via the base plate interface; and
the graphics processing module is used to receive a power signal from the base plate and output graphic data for being displayed via the base plate interface.

11. The core board of claim 10, wherein the core board PCB is a six-layer plate including four signal layers located respectively at a first layer, a third layer, a forth layer and a sixth layer of the core board PCB and two power layers that are two ground layers located respectively at a second layer and a fifth layer of the core board PCB.

12. A graphics card including:
a base plate; and
a core board, wherein
the base plate includes a base plate PCB and a core board interface slot, a power module and a graphics output interface located on the base plate PCB;
the core board includes a core board PCB and a base plate interface and a graphics processing module located on the core board PCB, and the core board is accommodated in the core board interface slot of the base plate and electrically connected with the base plate via the base plate interface;
the graphics processing module receives a power signal from the power module and output graphic data for being displayed via the base plate interface;
the graphics output interface is used to output the graphic data for being displayed that are received from the core board.

13. The graphics card of claim 12, wherein the base plate further includes a base plate interface for being connected with another base plate.

14. The graphics card of claim 12, wherein the core board PCB is a six-layer plate including four signal layers located respectively at a first layer, a third layer, a forth layer and a sixth layer of the core board PCB and two power layers that are two ground layers located respectively at a second layer and a fifth layer of the core board PCB.

15. The graphics card of claim 12, wherein the base plate PCB is a four-layer plate including two signal layers located respectively at a first layer and a forth layer of the base plate PCB and two power layers located respectively at a second layer and a third layer of the base plate PCB.

16. The graphics card of claim 12, wherein the base plate PCB is a six-layer plate including two power layers located respectively at a second layer and a fifth layer of the base plate PCB and four signal layers located respectively at a first layer, a third layer, a forth layer and a sixth layer of the base plate PCB.

17. The graphics card of claim 12, wherein the base plate PCB is a six-layer plate including four power layers located respectively at a second layer, a third layer, a forth layer and a fifth layer of the base plate PCB and two signal layers located respectively at a first layer and a sixth layer of the base plate PCB.

18. The graphics card of claim 12, wherein the base plate further includes a PCIE interface located on the base plate PCB and used to receive a data signal and a control signal that are to be transmitted to the core board via the core board interface slot.

19. The graphics card of claim 12, wherein the base plate further includes a power interface, which is located on the base plate PCB, connected with the power module and used for being connected with an external power.

20. The graphics card of claim 12, wherein the graphics processing module includes a graphics processing unit and a memory, and the power module includes a graphics processing unit power module for powering the graphics processing unit via the core board interface slot and a memory power module for powering the memory via the core board interface slot.
